(19) United States
(12) Patent Application Publication
(10) Pub. No.: US 2009/0327007 A1
(43) Pub. Date: Dec. 31, 2009

(54) INFORMATION PROCESSING SYSTEM, VALIDATION METHOD, INFORMATION PROCESSING DEVICE, AND PROGRAM

(76) Inventor: Masayuki IMANISHI, Kanagawa (JP)

Correspondence Address: FROMMER LAWRENCE & HAUG LLP, 745 FIFTH AVENUE, NEW YORK, NY, 10151, US

(21) Appl. No.: 12/493,372

(22) Filed: Jun. 29, 2009

(30) Foreign Application Priority Data
Jun. 30, 2008 (JP) P2008-171143

(51) Int. Cl. G06Q 10/00; G06Q 30/00

(52) U.S. Cl. 705/7; 705/26; 705/30

(57) ABSTRACT

An information processing system includes: a terminal device including a purchase information generating unit generating purchase information for relating a user who purchased a product to the purchased product, the purchase information identified by a predetermined identifier, a verification means generating unit generating verification means verifying correctness of the identifier, and a communication unit sending a purchase verification including the verification means and the identifier verified by the verification means to a terminal of the user; and an information processing device including a communication unit receiving word-of-mouth information entered by a user and a purchase verification when the word-of-mouth information involves it, a validation unit validating correctness of the identifier contained in the received purchase verification using the verification means, and a data holding unit holding purchaser word-of-mouth information having the identifier with correctness verified by the validation unit and non-purchaser word-of-mouth information as the word-of-mouth information other than the purchaser word-of-mouth information.

### BACKGROUND OF THE INVENTION

1. Field of the Invention

The present invention relates to an information processing system, validation method, information processing device, and program.

2. Background Art

In the past, one form of information propagation called word-of-mouth has existed, in which general consumers transmit evaluations and opinions on products they experienced. Today, communication networks are highly developed and a great deal of word-of-mouth information is shared via the communication networks.

As a case of positively utilizing the sharing of word-of-mouth information via networks, JP-2002-366831 discloses an advertisement delivery device for improving the effectiveness of providing advertisements by recording location information of a terminal as a transfer destination of word-of-mouth information or the like. Further, JP-2002-24680 discloses an information provision method for ranking word-of-mouth information transmitted from members having similar attributes according to a predetermined standard and providing the information to users.

### SUMMARY OF THE INVENTION

However, usually, the word-of-mouth information shared via the networks includes both of information with high credibility from users who actually purchased products and information with low credibility from users who did not purchase products. Accordingly, it has been difficult for consumers or businesses utilizing word-of-mouth information to determine the accuracy of information or the like for utilization of word-of-mouth information.

Thus, it is desirable to provide a new or improved information processing system, validation method, information processing device, and program that can determine whether word-of-mouth information is provided from users who actually purchased products or not.

According to an embodiment of the present invention, there is provided an information processing system having a terminal device including a purchase information generating unit that generates purchase information for relating a user who purchased a product to the purchased product, the purchase information identified by a predetermined identifier, a verification means generating unit that generates verification means for verification of correctness of the identifier, and a communication unit that sends a purchase verification including the verification means generated by the verification means generating unit and the identifier verified by the verification means to a terminal of the user, and an information processing device including a communication unit that receives word-of-mouth information entered by a user and a purchase verification when the word-of-mouth information involves the purchase verification, a validation unit that validates correctness of the identifier contained in the purchase verification received by the communication unit using the verification means, and a data holding unit that holds purchaser word-of-mouth information as the word-of-mouth information having the identifier with correctness verified by the validation unit and non-purchaser word-of-mouth information as the word-of-mouth information other than the purchaser word-of-mouth information.

According to the configuration, in a terminal device provided in a shop that provides products or the like, for example, the purchase information generating unit generates purchase information for relating a user who purchased a product to the purchased product, the purchase information identified by a predetermined identifier. Further, the verification means generating unit generates verification means for verification of correctness of the identifier. Furthermore, the communication unit sends a purchase verification including the verification means and the identifier verified by the verification means to a terminal of the user. In the information processing device that manages word-of-mouth information, the communication unit receives word-of-mouth information entered by a user and a purchase verification when the word-of-mouth information involves the purchase verification. Further, the validation unit validates correctness of the identifier contained in the received purchase verification using the verification means. Furthermore, the data holding unit holds purchaser word-of-mouth information as the word-of-mouth information having the identifier with verified correctness and non-purchaser word-of-mouth information as the word-of-mouth information other than the purchaser word-of-mouth information.

Additionally, the information processing device may further include a screen management unit that generates a word-of-mouth information display screen for displaying the word-of-mouth information held by the data holding unit.

Further, the word-of-mouth information display screen generated by the screen management unit may be a screen that distinguishes and displays the purchaser word-of-mouth information and the non-purchaser word-of-mouth information.

Furthermore, the word-of-mouth information display screen generated by the screen management unit may be a screen that displays only the purchaser word-of-mouth information.

Moreover, the information processing device may further include a word-of-mouth evaluation acquiring unit that acquires a word-of-mouth evaluation showing whether the word-of-mouth information displayed on the word-of-mouth information display screen is beneficial or not by allowing the user to enter the evaluation.

In addition, the information processing device may further include a reliability calculation unit that calculates reliability of the word-of-mouth information based on the word-of-mouth evaluation acquired by the word-of-mouth evaluation acquiring unit.

Further, the reliability calculation unit may calculate the reliability of the word-of-mouth information while weighting the word-of-mouth evaluation according to the number of purchases by the user who entered the word-of-mouth evaluation.

Furthermore, the reliability calculation unit may calculate the reliability of the word-of-mouth information while weighting the word-of-mouth evaluation according to whether the user who entered the word-of-mouth evaluation is the user who purchased the target product of the word-of-mouth information or not.

According to another embodiment of the prevent invention, there is provided a validation method including the steps of generating purchase information for relating a user who purchased a product to the purchased product, the purchase information identified by a predetermined identifier, generating verification means for verifying correctness of the identifier, sending a purchase verification including the verification means and the identifier verified by the verification means to a terminal of the user, receiving word-of-mouth information entered by a user and a purchase verification when the word-of-mouth information involves the purchase verification, validating correctness of the identifier contained in the received purchase verification using the verification means, and holding purchaser word-of-mouth information as the word-of-mouth information having the identifier with correctness verified as a result of validation and non-purchaser word-of-mouth information as the word-of-mouth information other than the purchaser word-of-mouth information.

According to still another embodiment of the prevent invention, there is provided an information processing device including a communication unit that receives word-of-mouth information entered by a user and a purchase verification including a predetermined identifier for identification of purchase information for relating a user who purchased a product to the purchased product and verification means for verification of correctness of the identifier when the word-of-mouth information involves the purchase verification, a validation unit that validates the correctness of the identifier contained in the purchase verification received by the communication unit using the verification means, and a data holding unit that holds purchaser word-of-mouth information as the word-of-mouth information having the identifier with correctness verified by the validation unit and non-purchaser word-of-mouth information as the word-of-mouth information other than the purchaser word-of-mouth information.

According to still another embodiment of the present invention, there is provided a program for allowing a computer that controls an information processing device to function as a communication unit that receives word-of-mouth information entered by a user and a purchase verification including a predetermined identifier for identification of purchase information for relating a user who purchased a product to the purchased product and verification means for verification of correctness of the identifier when the word-of-mouth information involves the purchase verification, a validation unit that validates the correctness of the identifier contained in the purchase verification received by the communication unit using the verification means, and a data holding unit that holds purchaser word-of-mouth information as the word-of-mouth information having the identifier with correctness verified by the validation unit and non-purchaser word-of-mouth information as the word-of-mouth information other than the purchaser word-of-mouth information.

As described above, according to the information processing system, validation method, information processing device, and program, whether word-of-mouth information is provided by users who actually purchased products or not can be determined.

### BRIEF DESCRIPTION OF THE DRAWINGS

FIG. 1 is a diagram schematically showing an information processing system according to one embodiment.

FIG. 2 is a block diagram showing a logical configuration of a shop terminal according to the one embodiment.

FIG. 3 is a block diagram showing a logical configuration of a user terminal according to the one embodiment.

FIG. 4 is a block diagram showing a logical configuration of a word-of-mouth management server according to the one embodiment.

FIG. 5 is an explanatory diagram showing an example of a word-of-mouth information display screen.

FIG. 6 is an explanatory diagram showing an example of data held in a data holding unit.

FIG. 7 is an explanatory diagram showing another example of the word-of-mouth information display screen.

FIG. 8 is a sequence diagram showing a flow of processing according to the one embodiment.

FIG. 9 is a block diagram showing a configuration example of a general-purpose computer.

### DESCRIPTION OF PREFERRED EMBODIMENTS

Hereinafter, a preferred embodiment of the invention will be explained with reference to the accompanying drawings. In the specifications and drawings, regarding component elements having substantially the same function configurations, the same signs are assigned thereto and the duplicate explanations will be omitted.

“DESCRIPTION OF PREFERRED EMBODIMENTS” will be described in the following order.

[1] Overview of information processing system

[2] Configuration example of shop terminal

[3] Configuration example of user terminal

[4] Configuration example of word-of-mouth management server

[5] Flow of processing according to the embodiment

### [1] Overview of Information Processing System

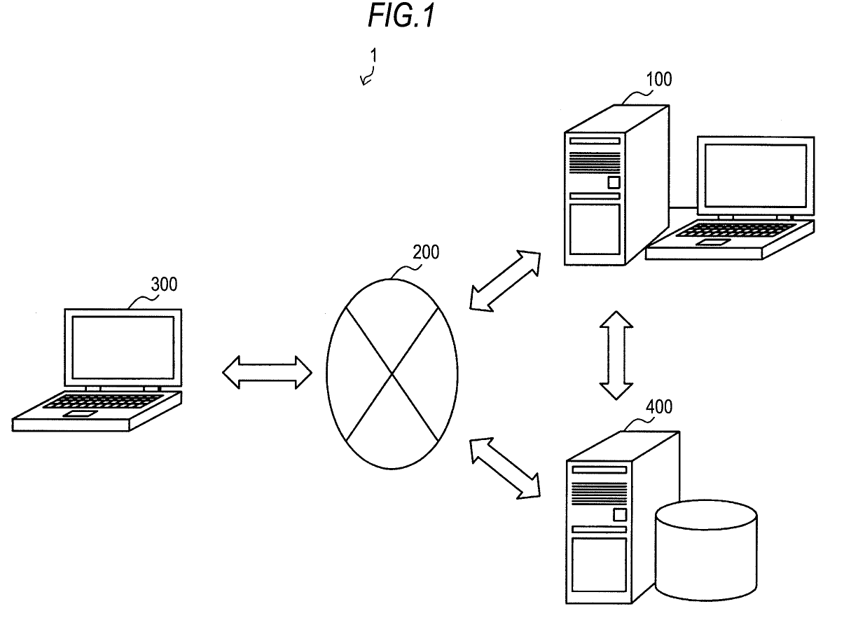

First, using FIG. 1, an overview of an information processing system 1 according to one embodiment of the invention will be explained.

FIG. 1 is a diagram schematically showing the information processing system 1 according to one embodiment of the invention. Referring to FIG. 1, the information processing system 1 includes a shop terminal 100, a communication network 200, a user terminal 300, and a word-of-mouth management server 400.

The shop terminal 100 is a terminal device used in a shop for providing products or the like. If the products provided in the information processing system 1 are products to be sold over the counter or the like, for example, the shop terminal 100 is installed within a shop. Further, if the products are products to be sold on the Web site or the like, for example, the shop terminal 100 may be an information processing device that opens a Web site or the like.

The shop terminal 100 is connected to the user terminal 300 via the communication network 200. Further, the shop terminal 100 is connected to the word-of-mouth management server 400. The shop terminal 100 and the word-of-mouth management server 400 may be connected via the communication network 200 or connected via another communication path such as LAN (Local Area Network).

The communication network 200 is a network mutually connecting the shop terminal 100, the user terminal 300, and the word-of-mouth management server 400. The communication network 200 may be Internet, PSTN (Public Switched Telephone Network), IP (Internet Protocol) telephone network, exclusive line, LAN, or WAN, for example.

The user terminal 300 is a terminal device used by a user who purchases products, posts word-of-mouth information, or the like. The user terminal 300 is connected to the shop terminal 100 and the word-of-mouth management server 400 via the communication network 200, for example.

In FIG. 1, PCs (Personal Computer) are shown as an example of the shop terminal 100 and the user terminal 300, however, the shop terminal 100 and the user terminal 300 are not limited to PCs. For example, the shop terminal 100 or the user terminal 300 may be a terminal device such as an IP telephone, IP videophone, or a cellular phone. Further, the shop terminal 100 or the user terminal 300 may have a function of a server.

The word-of-mouth management server 400 is an information processing device for management of word-of-mouth information posted by users. The word-of-mouth management server 400 is connected to the user terminal 300 via the communication network 200. Further, the word-of-mouth management server 400 is connected to the shop terminal 100 as described above.

In FIG. 1, single shop terminal 100, user terminal 300, and word-of-mouth management server 400 are shown, however, there may be some shop terminals 100, user terminals 300, and word-of-mouth management servers 400, respectively.

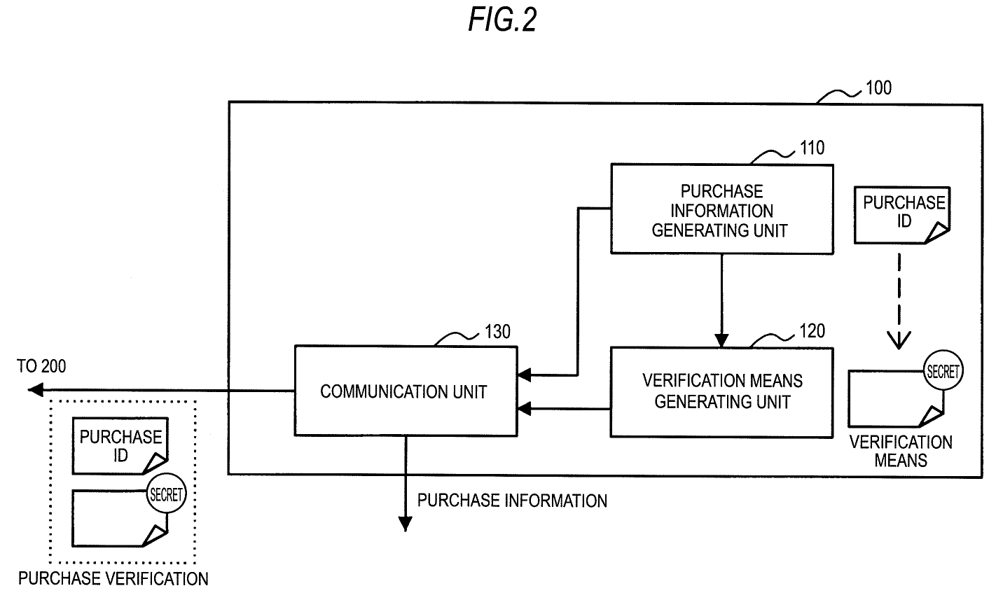

So far, the overview of an information processing system 1 has been explained. Next, using FIG. 2, a configuration example of the shop terminal 100 will be explained.

### [2] Configuration Example of Shop Terminal

FIG. 2 is a block diagram showing a configuration example of the shop terminal 100 according to the embodiment. Referring to FIG. 2, the shop terminal 100 includes a purchase information generating unit 110, a verification means generating unit 120, and a communication unit 130.

The purchase information generating unit 110 generates purchase information relating a user who purchased a product provided in the information processing system 1 to the purchased product, for example. For instance, if the product is sold over the counter in the real world, the purchase information generating unit 110 receives information entry by a clerk who sold the product or the like and generates purchase information. Further, if the product is electronically sold on a Web site, the purchase information generating unit 110 automatically acquires the sold product information and the user information and generates purchase information. Here, a purchase ID (IDentifier) for identification of individual information is assigned to the purchase information generated by the purchase information generating unit 110. The detailed contents of the purchase information will be explained later by taking examples.

The verification means generating unit 120 generates verification means for verification of correctness of the purchase ID assigned to the purchase information by the purchase information generating unit 110. For example, the verification means generating unit 120 may generate a pair of keys of a public key and a private key in advance to generate verification means by encrypting the purchase ID with the privacy key. In this case, the encrypted purchase ID is verification means for verification of correctness of the purchase ID. The public key forming a pair with the private key used for encryption is registered in the word-of-mouth management server 400 and used for validation processing, which will be described later. Further, the verification means may be a digital signature assigned to arbitrary information contained in the purchase information. Furthermore, the verification means may be a password to be authenticated with the purchase ID.

The communication unit 130 of the shop terminal 100 mediates the communication with the user terminal 300 and the communication with the word-of-mouth management server 400 via the communication network 200. For example, the communication unit 130 sends a purchase verification including the verification means generated by the verification means generating unit 120 and the purchase ID verified by the verification means to the user terminal 300 used by the user who purchased the product via the communication network 200. The transmission of the purchase verification by the communication unit 130 may be performed using file transfer according to FTP (File Transfer Protocol) and HTTP (Hyper-Text Transfer Protocol) or INFO method of SIP (Session Initiation Protocol). It is preferable that the communication unit 130 encrypts the communication path using SSL (Secure Sockets Layer) or TLS (Transport Layer Security) in advance. Further, the communication unit 130 may send the purchase information generated by the purchase information generating unit 110 to the word-of-mouth management server 400.

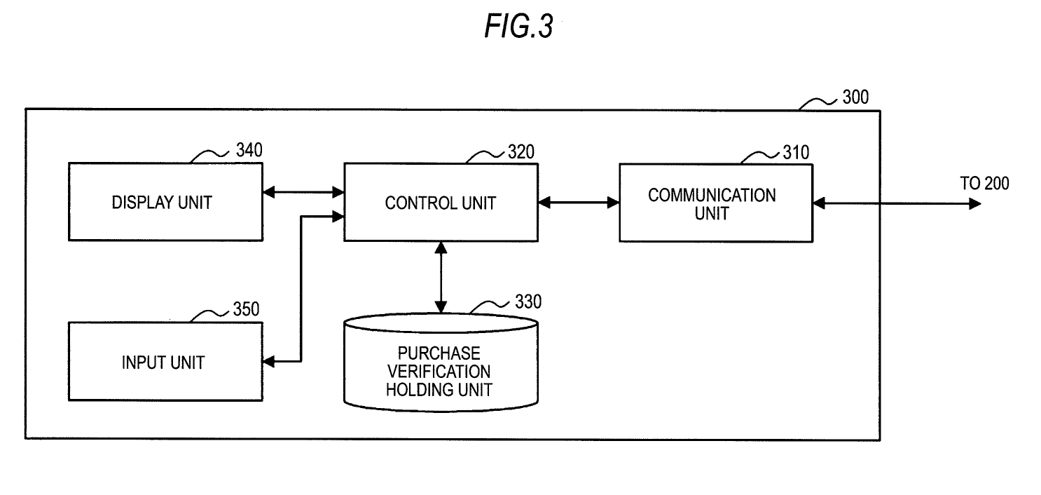

So far, the configuration example of the shop terminal 100 has been explained. Next, using FIG. 3, a configuration example of the user terminal 300 will be explained.

### [3] Configuration Example of User Terminal

FIG. 3 is a block diagram showing a configuration example of the user terminal 300 according to the embodiment. Referring to FIG. 3, the user terminal 300 includes a communication unit 310, a control unit 320, a purchase verification holding unit 330, a display unit 340, and an input unit 350.

The communication unit 310 of the user terminal 300 mediates the communication with shop terminal 100 or the word-of-mouth management server 400 via the communication network 200. For example, the communication unit 310 receives the above described purchase verification transmitted from the communication unit 130 of the shop terminal 100. The purchase verification received by the communication unit 310 is transferred to the control unit 320. Further, the communication unit 310 sends the word-of-mouth information entered by users, which will be described later, to the word-of-mouth management server 400. Concurrently, as described below, the purchase verification can be sent with the word-of-mouth information from the communication unit 310. It is suitable that the communication unit 310 encrypts the communication path with the word-of-mouth management server 400 using SSL or TLS in advance.

The control unit 320 controls the overall operation of the user terminal 300. For example, the control unit 320 saves the purchase verification transferred from the communication unit 310 in the purchase verification holding unit 330. Further, when word-of-mouth information is entered by a user via the input unit 350, the control unit 320 sends the entered word-of-mouth information from the communication unit 310 to the word-of-mouth management server 400. Concurrently, the control unit 320 acquires according to the choice of the user or automatically the purchase verification related to the word-of-mouth information from the purchase verification holding unit 330, and sends it together.

The purchase verification holding unit 330 uses a storage device including a hard disk drive or flash memory, for example, to save the purchase verification including the verification means and the purchase ID verified by the verification means according to a command from the control unit 320.

The display unit 340 displays various screens provided for use of users for users using a display device. For example, the display unit 340 displays a screen for entering word-of-mouth information of a product provided by the information processing system 1. Further, a screen for referring to word-of-mouth information on a predetermined product or shop or the like may be displayed by the display unit 340. The screens displayed by the display unit 340 will be explained later by taking examples.

The input unit 350 receives commands and information entry from users using an input device such as a keyboard, mouse or microphone. For example, the input unit 350 receives entry of word-of-mouth information containing comments and satisfaction levels regarding the product provided in the information processing system 1. Then, the input unit 350 outputs the received information to the control unit 320.

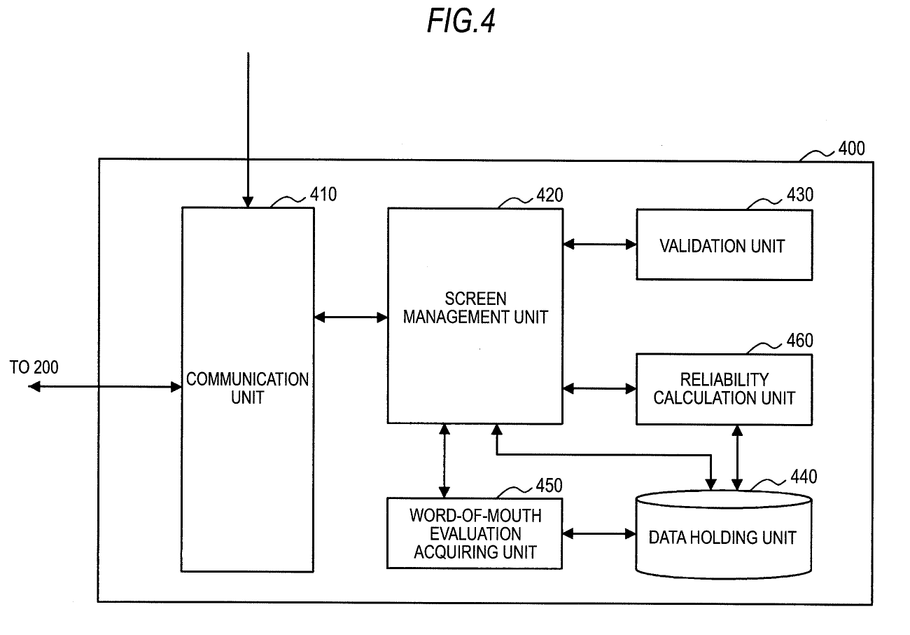

So far, the configuration example of the user terminal 300 has been explained. Next, using FIGS. 4 to 7, a configuration example of the word-of-mouth management server 400 will be explained.

### [4] Configuration Example of Word-of-Mouth Management Server

FIG. 4 is a block diagram showing a configuration example of the word-of-mouth management server 400 according to the embodiment. Referring to FIG. 4, the word-of-mouth management server 400 includes a communication unit 410, a screen management unit 420, a validation unit 430, a data holding unit 440, a word-of-mouth evaluation acquiring unit 450, and a reliability calculation unit 460.

The communication unit 410 of the word-of-mouth management server 400 mediates the communication with the user terminal 300 and the communication with the shop terminal 100 via the communication network 200. For example, the communication unit 410 receives the word-of-mouth information sent from the communication unit 310 of the user terminal 300. Further, when the word-of-mouth information is sent with the purchase verification, the unit receives the word-of-mouth information and the purchase verification. Furthermore, the communication unit 410 sends contents of the screen generated by the screen management unit 420, which will be described later, to the user terminal 300. The communication unit 130 may receive the purchase information generated by the purchase information generating unit 110 of the shop terminal 100 from the shop terminal 100.

The screen management unit 420 generates a screen for a user of the information processing system 1 or a provider of a product or the like to refer to or enter information. For example, the screen management unit 420 generates a screen for a user to enter word-of-mouth information and allows the user terminal 300 to display it. Further, the screen management unit 420 may generate a word-of-mouth information display screen for displaying word-of-mouth information held in the data holding unit 440, which will be described later, for the user. The contents of the screen generated by the screen management unit 420 are sent to the shop terminal 100 or user terminal 300 via the communication unit 410.

The validation unit 430 validates the correctness of the purchase ID contained in the purchase verification received by the communication unit 410 using the verification means contained in the same purchase verification. For example, assuming the verification means is a purchase ID encrypted using a private key in the shop terminal 100, the validation unit 430 can validate the correctness of the received purchase ID by decrypting the purchase ID using the corresponding public key previously generated and registered by the shop terminal 100 and comparing the decrypted purchase ID and the received purchase ID. Further, for example, when the verification means is a password to be authenticated with the purchase ID, the unit can validate the correctness of the received purchase ID by authenticating the combination of the received purchase ID and the password.

The data holding unit 440 holds various kinds of data managed by the word-of-mouth management server 400 using a storage device including a hard disk drive or flash memory, for example. For instance, the data holding unit 440 holds the above described word-of-mouth information received by the communication unit 410. In this regard, the data holding unit 440 distinguishes between word-of-mouth information (hereinafter, referred to as purchaser word-of-mouth information) having the purchase ID with the correctness verified by the validation unit 430 and word-of-mouth information other than the purchaser word-of-mouth information (hereinafter, referred to as non-purchaser word-of-mouth information) and holds them. Further, the data holding unit 440 may hold user information on users of the information processing system 1, product information on products to be provided, shop information, etc.

The word-of-mouth evaluation acquiring unit 450 acquires word-of-mouth evaluations showing whether the word-of-mouth information displayed on the word-of-mouth information display screen displayed for the users by the screen management unit 420 are beneficial or not according to the entry operation of the users into the word-of-mouth information display screen, for example. The evaluations of the word-of-mouth information acquired by the word-of-mouth evaluation acquiring unit 450 are held in relation to the word-of-mouth information by the data holding unit 440.

The reliability calculation unit 460 calculates reliability of respective word-of-mouth information based on the above described word-of-mouth evaluations acquired by the word-of-mouth evaluation acquiring unit 450. The reliability calculation unit 460 may calculate reliability while weighting word-of-mouth evaluations according to the number of purchases of products by the users who entered the word-of-mouth evaluations, for example. Further, the reliability calculation unit 460 may calculate reliability while weighting word-of-mouth evaluations according to whether the users who entered the word-of-mouth evaluations are users who purchased the target products of the word-of-mouth information or not. Details of the reliability calculated by the reliability calculation unit 460 will be further explained later by showing data examples.

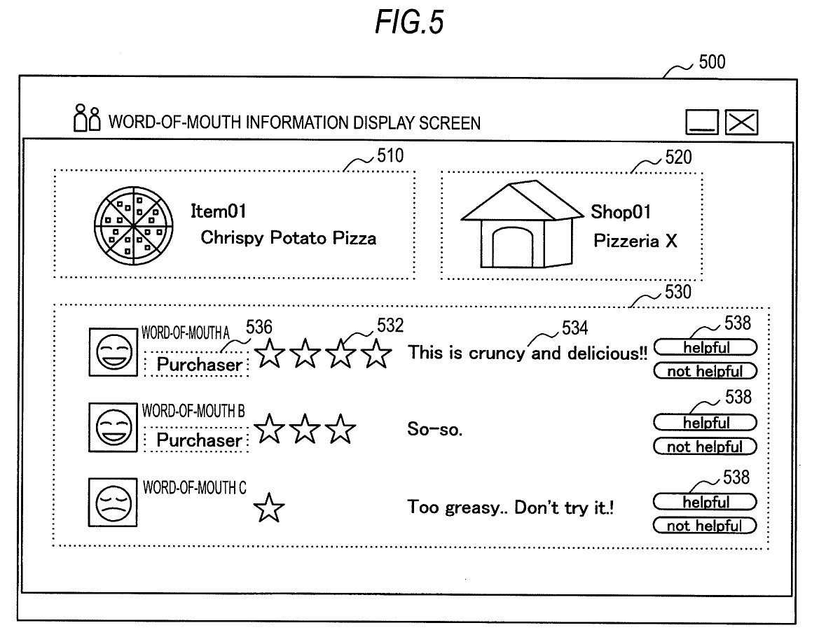

FIG. 5 is an explanatory diagram showing a word-of-mouth information display screen 500 as an example. Referring to FIG. 5, the word-of-mouth information display screen 500 includes a product information display area 510, a shop information display area 520, and a word-of-mouth information display area 530.

In the product information display area 510, an image of a product word-of-mouth information of which is being displayed, a product ID, and a product name are displayed. Further, in the shop information display area 520, an image of a shop that provides the product word-of-mouth information of which is being displayed, a shop ID, and a shop name are displayed.

In the word-of-mouth information display area 530, three pieces of word-of-mouth information of word-of-mouth A, word-of-mouth B and word-of-mouth C are displayed. In the example of FIG. 5, each word-of-mouth information contains a score 532 expressed by the number of stars and a comment 534 freely entered. The score 532 shows a satisfactory level for the product entered by a user who posted each word-of-mouth information or the like. Further, the comment 534 shows the comment for the product entered by the user who posted each word-of-mouth information.

Furthermore, in the word-of-mouth information display area 530, a purchaser icon 536 and an evaluation button 538 are displayed. The purchaser icon 536 shows that the word-of-mouth information is information posted by a purchaser who actually purchased the product (Item01 in the example of FIG. 5). That is, in the example of FIG. 5, the word-of-mouth A and word-of-mouth B are information posted by the users who actually purchased the Item01. On the other hand, word-of-mouth C is information posted by the user who did not actually purchase the Item01.

When the word-of-mouth management server 400 receives word-of-mouth information, such a purchaser icon 536 is assigned to word-of-mouth information with verified correctness as a result of validation of the correctness of the purchase ID contained in the purchase verification received with the word-of-mouth information by the validation unit 430. That is, the word-of-mouth information to which the purchaser icon 536 has been assigned is purchaser word-of-mouth information. According to the configuration of the screen, a user who refers to the word-of-mouth information display screen 500 can determine whether the word-of-mouth information is purchaser word-of-mouth information or not and estimate the credibility, accuracy, or the like of the word-of-mouth information.

Further, the evaluation button 538 is a button for the user who refers to the word-of-mouth information display screen 500 to operate for notification as to whether each word-of-mouth information is beneficial or not. For example, if word-of-mouth information is helpful for selection of the product, the user can notify its evaluation by pressing down the button (“helpful”) showing that the information is helpful. Further, for example, if word-of-mouth information is not helpful, the user can notify its evaluation by pressing down the button (“not helpful”) showing that the information is not helpful.

If the evaluation button 538 is pressed down by the user, a value of word-of-mouth evaluation (a logic value expressing whether the information is beneficial or not or the like) and information that identifies the word-of-mouth information are sent from the user terminal 300 on which the word-of-mouth information display screen 500 is being displayed to the word-of-mouth management server 400. Then, these information are acquired by the word-of-mouth evaluation acquiring unit 450 of the word-of-mouth management server 400 and stored in the data holding unit 440.

In the word-of-mouth information display screen 500 shown in FIG. 5, for example, only the word-of-mouth information posted by the purchaser who actually purchased the product (i.e., the word-of-mouth A and word-of-mouth B) may be selected and displayed. In this case, the word-of-mouth information that may have low credibility is eliminated in advance, and the word-of-mouth information with high credibility can be more easily referred to.

Further, the contents of the word-of-mouth information display screen 500 are not limited to the example shown in FIG. 5. For example, average values of scores of the satisfactory levels or the like contained in the word-of-mouth information may be displayed on the word-of-mouth information display screen 500. Furthermore, the average values may be average values of scores contained in all word-of-mouth information or average values of scores contained only in the purchaser word-of-mouth information.

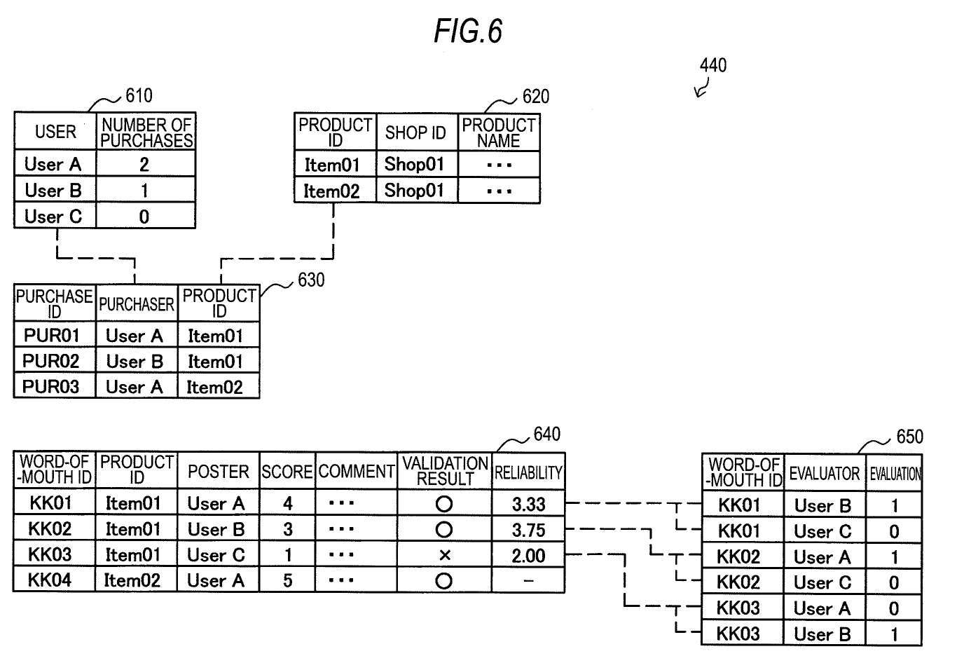

FIG. 6 is an explanatory diagram showing an example of data held in the data holding unit 440 of the word-of-mouth management server 400.

Referring to FIG. 6, the data holding unit 440 holds user information 610, product information 620, purchase information 630, word-of-mouth information 640 and word-of-mouth evaluations 650.

The user information 610 and the product information 620 are typically information registered in the word-of-mouth management server 400 in advance. The user information 610 includes user IDS for identification of users, the number of purchases of the respective users, etc., for example. In the example of FIG. 6, three users of User A, User B and User C are registered. On the other hand, the product information 620 includes product IDS for identification of products, shop IDS for identification of shops where the respective products are provided, product names, etc., for example. In the example of FIG. 6, two products of Item01 and Item02 are registered.

The purchase information 630 is typically generated by the purchase information generating unit 110 of the shop terminal 100 at each time when products are purchased and sent to the word-of-mouth management server 400. The purchase information 630 includes purchase IDs for unique identification of purchase information, user IDs of purchasers who purchased products, product IDs of the purchased products, etc., for example. In the example of FIG. 6, three pieces of purchase information of PUR 01, PUR 02 and PUR 03 are held.

The word-of-mouth information 640 is sent from the user terminal 300 to the word-of-mouth management server 400 as described above. The word-of-mouth information 640 includes word-of-mouth IDs for identification of word-of-mouth information, product IDs as targets of word-of-mouth information, user IDs of posters who posted word-of-mouth information, scores showing the above described satisfactory levels or the like, comments by the posters, etc.

Furthermore, a validation result showing whether the correctness of the purchase ID contained in the purchase verification sent with the word-of-mouth information is verified or not as a result of validation by the validation unit 430 is assigned to the word-of-mouth information 640. In the example of FIG. 6, circles are assigned to the validation results of the word-of-mouth information KK01, KK02 and KK04 to which circles are assigned. That is, the word-of-mouth information KK01, KK02 and KK04 are purchaser word-of-mouth information posted by users who actually purchased products. On the other hand, the word-of-mouth information KK03 is non-purchaser word-of-mouth information posted by the users who did not actually purchased the products, and crosses are assigned to the validation results.

Further, the word-of-mouth information 640 also includes reliability calculated by the reliability calculation unit 460. The reliability of the word-of-mouth information 640 is calculated based on the word-of-mouth evaluation 650 by the reliability calculation unit 460.

The word-of-mouth evaluations 650 are sent from the user terminal 300 to the word-of-mouth management server 400 as described above. The word-of-mouth evaluations 650 include word-of-mouth IDs for identification of word-of-mouth information, user IDs of evaluators who entered evaluations of word-of-mouth information, details of evaluations, etc., for example. The details of evaluations may be expressed as “1” if the word-of-mouth information is evaluated to be beneficial, or “0” if not. In the example of FIG. 6, two word-of-mouth evaluations are held with respect to each of the word-of-mouth information KK01, KK02 and KK03.

On the basis of the word-of-mouth evaluations 650, the reliability calculation unit 460 may calculate reliability while weighting the word-of-mouth evaluations according to the number of purchases of products by the users who entered the word-of-mouth evaluations (i.e., evaluators), for example.

Equation (1) is an example of a calculation formula for calculation of reliability R according to the number of purchases of products of evaluators.

$$R = \frac{{\sum }_{k = 1}^{n} ( {S}_{k} ( 1 + {N}_{k} ) )}{{\sum }_{k = 1}^{n} ( 1 + {N}_{k} )} \times 5$$

In equation (1), n represents the number of evaluators, k represents identification number of the individual evaluators (k=1 to n), Sₖ represents a value of word-of-mouth evaluation by the evaluator k, and Nₖ represents the number of purchases of products by the evaluator k. In the data example in FIG. 6, according to equation (1), the reliability R₁, R₂ and R₃ of the word-of-mouth information KK01, KK02 and KK03 are calculated as below.

$${R}_{1} = \frac{( 1 \times ( 1 + 1 ) + 0 \times ( 1 + 0 )}{( 1 + 1 ) + ( 1 + 0 )} \times 5 ≅ 3.33$$

$${R}_{2} = \frac{( 1 \times ( 1 + 2 ) + 0 \times ( 1 + 0 )}{( 1 + 2 ) + ( 1 + 0 )} \times = 3.75$$

$${R}_{3} = \frac{( 0 \times ( 1 + 2 ) + 1 \times ( 1 + 1 )}{( 1 + 2 ) + ( 1 + 1 )} \times 5 = 2.00$$

Each of the word-of-mouth information KK01, KK02 and KK03 shown in FIG. 6 obtains one word-of-mouth evaluation that the word-of-mouth information is beneficial. That is, assuming that the number of evaluations of being beneficial are simply used as the reliability of each word-of-mouth information without weighting, the reliability of all of the word-of-mouth information KK01, KK02 and KK03 is “1”. However, as understood from the equations (2) to (4), by weighting of reliability according to the number of purchases by evaluators, reliability focusing on the evaluations by the evaluators who experienced more products can be calculated. Thereby, the credibility or accuracy of word-of-mouth information provided from the word-of-mouth management server 400 to the users can be determined on more objective criteria.

Similarly, the reliability calculation unit 460 may calculate reliability while weighting the word-of-mouth evaluations according to whether the users who entered the word-of-mouth evaluations are users who purchased target products of word-of-mouth information, for example.

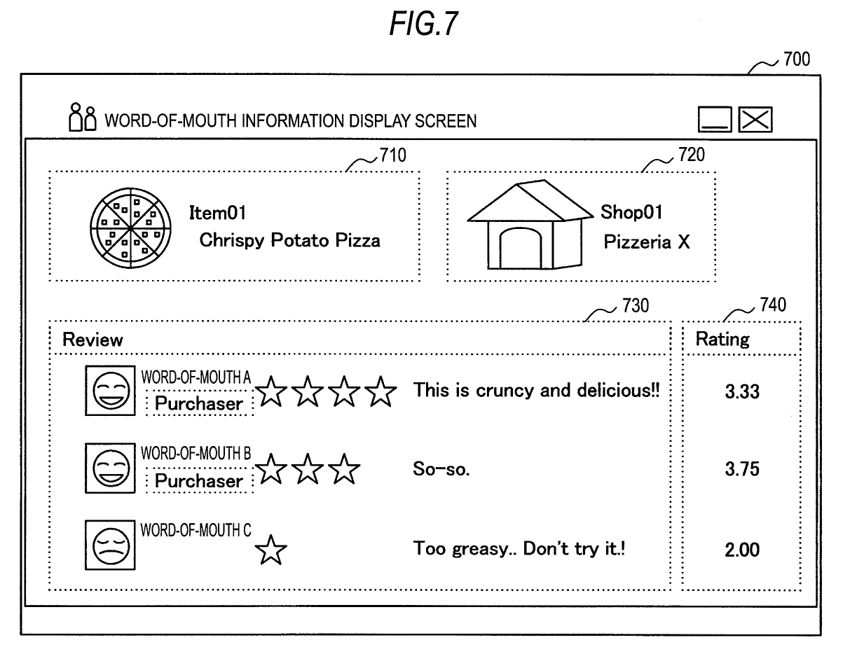

FIG. 7 is an explanatory diagram showing a screen 700 as another example of the word-of-mouth information display screen. Referring to FIG. 7, the word-of-mouth information display screen 700 includes a product information display area 710, a shop information display area 720, a word-of-mouth information display area 730, and a reliability display area 740.

In the product information display area 710, the shop information display area 720, and the word-of-mouth information display area 730, the same contents as those in the product information display area 510, the shop information display area 520, and the word-of-mouth information display area 530 shown in FIG. 5 are displayed. Further, in the reliability display area 740, reliability with respect to each word-of-mouth information displayed in the word-of-mouth information display area 730 is displayed based on the calculation results of the above described equations (2) to (4).

So far, using FIGS. 4 to 7, the configuration example of the word-of-mouth management server has been explained. Next, a flow of processing according to the embodiment will be explained.

### [5] Flow of Processing According to the Embodiment

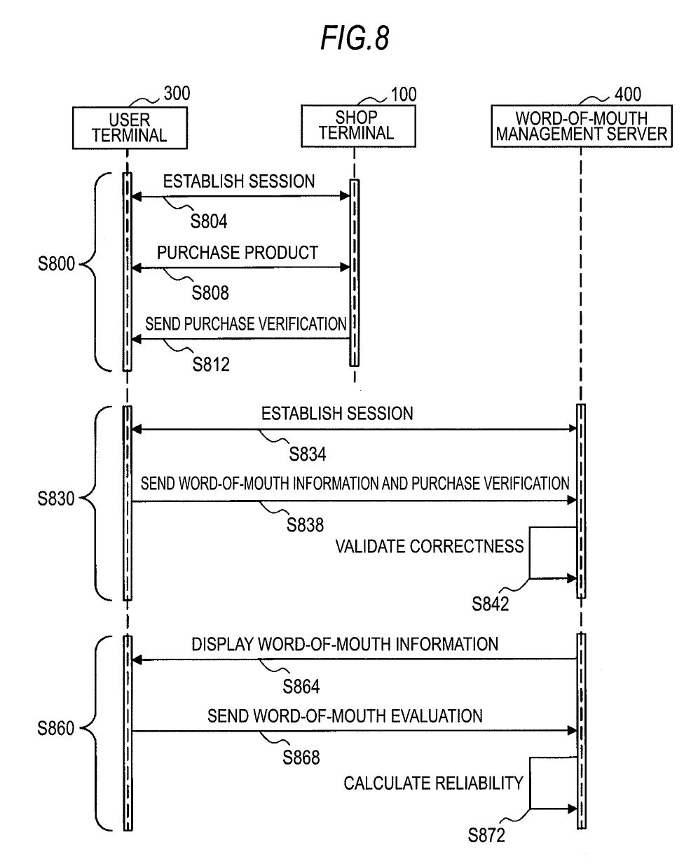

FIG. 8 is a sequence diagram showing an example of the flow of processing by an information processing system 1 according to the embodiment. In FIG. 8, the processing by the information processing system 1 according to the embodiment is divided into a product purchase stage S800, a word-of-mouth information transmission stage S830, and a word-of-mouth information display stage S860.

### [5-1] Product Purchase Stage

At the product purchase stage S800, first, a communication session is established between the user terminal 300 and the shop terminal 100 (S804). The session established here may be an HTTP session or SIP session, for example. Further, it is preferable to improve security of communication paths in the session according to protocols such as SSl or TLS.

After the session is established, if a product is sold or purchased on a Web site, sell and purchase processing of the product is performed (S808). When a product is sold or purchased over the counter of a real shop, the step may be omitted.

When the product is purchased, purchase information is generated by the purchase information generating unit 110 of the shop terminal 100, and verification means for verification of correctness of a purchase ID for identification of the purchase information is generated by the verification means generating unit 120. Then, the purchase verification containing the generated purchase ID and verification means is sent from the communication unit 130 to a terminal of a user who purchased the product (S812).

This is the end of the product purchase stage S800. Though not specifically shown in FIG. 8, a public key for validation of the purchase verification generated in the shop terminal 100 or the like may be sent from the shop terminal 100 to the word-of-mouth management server 400 at a stage prior to the product purchase stage S800 and registered as initial settings.

### [5-2] Word-of-Mouth Information Transmission Stage

At the word-of-mouth information transmission stage S830, first, a communication session is established between the user terminal 300 and the word-of-mouth management server 400 (S834).

Then, word-of-mouth information entered by a user is sent from the user terminal 300 to the word-of-mouth management server 400. In this regard, if word-of-mouth information on a product actually purchased by the user is sent, the purchase verification sent from the shop terminal 100 at the product purchase stage S800 is sent with the word-of-mouth information (S838).

Then, when the word-of-mouth information is received in the word-of-mouth management server 400, the correctness of the purchase ID contained in the purchase verification sent with the word-of-mouth information is validated using the verification means by the validation unit 430 of the word-of-mouth management server 400 (S842). As a result, the word-of-mouth information is held by the data holding unit 440 so that purchaser word-of-mouth information and non-purchaser word-of-mouth information may be distinguished. This is the end of the word-of-mouth information transmission stage S830.

### [5-3] Word-of-Mouth Information Display Stage

At the word-of-mouth information display stage S860, a word-of-mouth information display screen is generated by the screen management unit 420 of the word-of-mouth management server 400 that has received the request from the user, and displayed by the display unit 340 of the user terminal 300 (S864). In this regard, as shown in FIG. 5, for example, purchaser word-of-mouth information and non-purchaser word-of-mouth information are distinguished and displayed.

Then, a word-of-mouth evaluation showing whether the word-of-mouth information is beneficial or not is entered by a user who referred to the word-of-mouth information, and sent from the communication unit 310 of the user terminal 300 to the word-of-mouth management server 400 (S868).

Then, when the word-of-mouth evaluation is received in the word-of-mouth management server 400, reliability of the word-of-mouth information is calculated by the reliability calculation unit 460 of the word-of-mouth management server 400 (S872). The calculated reliability is held in the data holding unit 440. In this regard, the word-of-mouth information display screen displayed at S864, for example, may be updated using newly calculated reliability. This is the end of the word-of-mouth information display stage S860.

So far, the flow of processing executed by the information processing system 1 in the embodiment has been explained. According to the embodiment, the purchase verification showing that the product has been purchased and the word-of-mouth information are sent, and the purchase verification can be validated in the word-of-mouth management server 400 and whether each word-of-mouth information is information provided by the user who actually purchased the product or not can be determined.

Thereby, determination of credibility or accuracy of the word-of-mouth information by the user referring to the word-of-mouth information or the provider of the product becomes easy. Further, various provision forms of word-of-mouth information can be obtained such that only the purchaser word-of-mouth information posted by the provider of the product can be selected and displayed.

Further, when calculating reliability of the word-of-mouth information based on the evaluations of the word-of-mouth information, the word-of-mouth management server 400 may calculate reliability while weighting the evaluations according to the number of purchases of the product of the evaluators or whether the evaluators are users who purchased the target product of the word-of-mouth information or not. Thereby, the reliability of word-of-mouth information can be made a more objective value that is based on the real experiences of the actual purchasers.

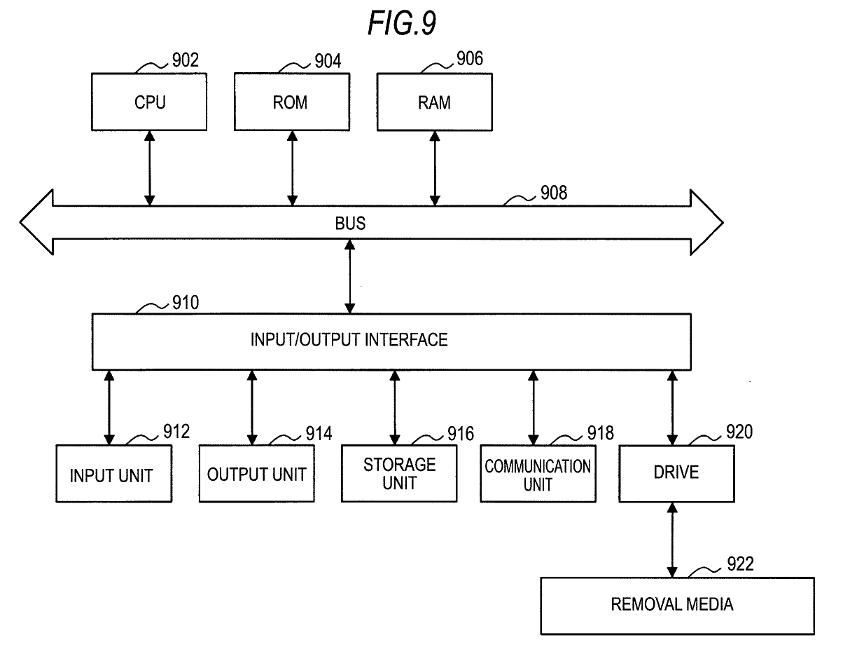

All or part of the processing of the shop terminal 100, the user terminal 300, and the word-of-mouth management server 400 is typically realized by software. In the case where all of part of the series of processing is executed by software, programs configuring the software are executed using a computer incorporated in exclusive hardware or a general-purpose computer shown in FIG. 9, for example.

In FIG. 9, a CPU (Central Processing Unit) 902 controls the overall operation of the general-purpose computer. In a ROM (Read Only Memory) 904, programs or data describing all of part of the series of processing are stored. In a RAM (Random Access Memory) 906, programs and data used for arithmetic processing by the CPU 902 are temporarily stored.

The CPU 902, ROM 904, and RAM 906 are mutually connected via a bus 908. The bus 908 is further connected to an input/output interface 910.

The input/output interface 910 is an interface for connecting between the CPU 902, the ROM 904, and the RAM 906 and an input unit 912, an output unit 914, a storage unit 916, a communication unit 918, and a drive 920.

The input unit 912 receives commands and information entry from users using an input device such as a mouse, keyboard, button, switch, or microphone. The output unit 914 outputs information to the users via a display device such as a CRT (Cathode Ray Tube), liquid crystal display, or OLED (Organic light Emitting Diode), or a sound output device such as a speaker.

The storage unit 916 includes a hard disk drive or flash memory, for example, and stores programs and various kinds of information. The communication unit 918 performs communication processing via a communication network such as LAN (Local Area Network) or Internet. The drive 920 is provided in the general-purpose computer according to need. For example, a removable media 922 is placed in the drive 920.

The programs for executing the series of processing as software are stored in the ROM 904, the storage unit 916, or the removable media 922 shown in FIG. 9, for example, and loaded in the RAM 906 at execution, and executed by the CPU 902.

As described above, the preferred embodiment of the invention has been explained by referring to the accompanying drawings, however, it is apparent that the invention is not limited to the examples. It would be obvious that a person skilled in the art could think of various alterations or modifications within a category described in claims, and it would be naturally understood that those belong to the technical scope of the invention.

For example, in the embodiment explained herein, the shop terminal 100 and the word-of-mouth management server 400 have been explained as a terminal device and an information processing device which are separately configured, however, the shop terminal 100 and the word-of-mouth management server 400 may be mounted on the same hardware. In this case, the purchase information generated in the shop terminal 100 may be directly written in the data holding unit 440 instead of being sent from the shop terminal 100 to the word-of-mouth management server 400.

Further, the word-of-mouth information posted as text information has been explained in FIGS. 5 and 7, however, the word-of-mouth information is not limited to text information. For example, the word-of-mouth information may be sound information posted using an IP telephone or sound information with moving images.

The present application contains subject matter related to that disclosed in Japanese Priority Patent Application JP 2008-171143 filed in Japan Patent Office on Jun. 30, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing system comprising:
a terminal device including
a purchase information generating unit that generates purchase information for relating a user who purchased a product to the purchased product, the purchase information identified by a predetermined identifier,
a verification means generating unit that generates verification means for verification of correctness of the identifier, and
a communication unit that sends a purchase verification including the verification means generated by the verification means generating unit and the identifier verified by the verification means to a terminal of the user; and
an information processing device including
a communication unit that receives word-of-mouth information entered by a user and a purchase verification when the word-of-mouth information involves the purchase verification,
a validation unit that validates correctness of the identifier contained in the purchase verification received by the communication unit using the verification means, and
a data holding unit that holds purchaser word-of-mouth information as the word-of-mouth information having the identifier with correctness verified by the validation unit and non-purchaser word-of-mouth information as the word-of-mouth information other than the purchaser word-of-mouth information.

2. The information processing system according to claim 1, wherein the information processing device further includes a screen management unit that generates a word-of-mouth information display screen for displaying the word-of-mouth information held by the data holding unit.

3. The information processing system according to claim 2, wherein the word-of-mouth information display screen generated by the screen management unit is a screen that distinguishes and displays the purchaser word-of-mouth information and the non-purchaser word-of-mouth information.

4. The information processing system according to claim 2, wherein the word-of-mouth information display screen generated by the screen management unit is a screen that displays only the purchaser word-of-mouth information.

5. The information processing system according to claim 2, wherein the information processing device further includes a word-of-mouth evaluation acquiring unit that acquires a word-of-mouth evaluation showing whether the word-of-mouth information displayed on the word-of-mouth information display screen is beneficial or not by allowing the user to enter the evaluation.

6. The information processing system according to claim 5, wherein the information processing device further includes a reliability calculation unit that calculates reliability of the word-of-mouth information based on the word-of-mouth evaluation acquired by the word-of-mouth evaluation acquiring unit.

7. The information processing system according to claim 6, wherein the reliability calculation unit calculates the reliability of the word-of-mouth information while weighting the word-of-mouth evaluation according to the number of purchases by the user who entered the word-of-mouth evaluation.

8. The information processing system according to claim 6, wherein the reliability calculation unit calculates the reliability of the word-of-mouth information while weighting the word-of-mouth evaluation according to whether the user who entered the word-of-mouth evaluation is the user who purchased the target product of the word-of-mouth information or not.

9. A validation method comprising the steps of:
generating purchase information for relating a user who purchased a product to the purchased product, the purchase information identified by a predetermined identifier;
generating verification means for verifying correctness of the identifier;
sending a purchase verification including the verification means and the identifier verified by the verification means to a terminal of the user;
receiving word-of-mouth information entered by a user and a purchase verification when the word-of-mouth information involves the purchase verification;
validating correctness of the identifier contained in the received purchase verification using the verification means; and
holding purchaser word-of-mouth information as the word-of-mouth information having the identifier with correctness verified as a result of validation and non-purchaser word-of-mouth information as the word-of-mouth information other than the purchaser word-of-mouth information.

10. An information processing device comprising:
a communication unit that receives word-of-mouth information entered by a user and a purchase verification including a predetermined identifier for identification of purchase information for relating a user who purchased a product to the purchased product and verification means for verification of correctness of the identifier when the word-of-mouth information involves the purchase verification;
a validation unit that validates the correctness of the identifier contained in the purchase verification received by the communication unit using the verification means; and
a data holding unit that holds purchaser word-of-mouth information as the word-of-mouth information having the identifier with correctness verified by the validation unit and non-purchaser word-of-mouth information as the word-of-mouth information other than the purchaser word-of-mouth information.

11. A program for allowing a computer that controls an information processing device to function as:
a communication unit that receives word-of-mouth information entered by a user and a purchase verification including a predetermined identifier for identification of purchase information for relating a user who purchased a product to the purchased product and verification means for verification of correctness of the identifier when the word-of-mouth information involves a purchase verification;
a validation unit that validates the correctness of the identifier contained in the purchase verification received by the communication unit using the verification means; and
a data holding unit that holds purchaser word-of-mouth information as the word-of-mouth information having the identifier with correctness verified by the validation unit and non-purchaser word-of-mouth information as the word-of-mouth information other than the purchaser word-of-mouth information.
